(19) United States
(12) Patent Application Publication
(10) Pub. No.: US 2026/0331850 A1
(43) Pub. Date: Oct. 22, 2026

(54) FEMALE PLUG OUTPUT INTERFACE FOR CONTROLLER

(71) Applicant: TAIZHOU TONGFENG PHOTOELECTRIC TECHNOLOGY CO., LTD, Taizhou (CN)

(72) Inventor: Yuqian Zhang, Taizhou (CN)

(73) Assignee: TAIZHOU TONGFENG PHOTOELECTRIC TECHNOLOGY CO., LTD, Taizhou (CN)

(21) Appl. No.: 19/419,340

(22) Filed: Dec. 15, 2025

(30) Foreign Application Priority Data
Apr. 16, 2025 (CN) 202520723832.X
Nov. 25, 2025 (CN) 202522498845.4
Nov. 25, 2025 (CN) 202530693239.0

(51) Int. Cl. H01R 24/86; H01R 12/75; H01R 13/52; H01R 13/622; H01R 13/66; H01R 103/00

(52) U.S. Cl. CPC H01R 24/86; H01R 12/75; H01R 13/5202; H01R 13/622; H01R 13/6675; H01R 2103/00

(57) ABSTRACT

A female plug output interface for a controller is provided, including a housing and a control mainboard arranged inside the housing. The housing is provided with an output connection assembly and an input connection assembly. The output connection assembly includes an integrally connected conductive contact sheet arranged at one end of the control mainboard and an output connector that is arranged at one end of the housing and is configured to mount the conductive contact sheet. The output connector includes a connection port for being threadedly connected to electrical equipment, two through holes symmetrically formed inside the connection port, and a connection slot that is arranged between the two through holes and is configured to insert and fix the conductive contact sheet. When an external connector is inserted into the connection port, electrodes inside the external connector are electrically connected to two sides of the conductive contact sheet.

### RELATED APPLICATIONS

The present patent document claims the benefit of priority to Patent Application No. 202520723832.X, filed Apr. 16, 2025, and entitled “CONTROLLER WITH FEMALE PLUG OUTPUT INTERFACE INTEGRATED ON MAINBOARD,” the entire contents of each of which are incorporated herein by reference.

The present patent document claims the benefit of priority to Patent Application No. 202530693239.0, filed Nov. 25, 2025, and entitled “POWER BANK CONTROLLER,” the entire contents of each of which are incorporated herein by reference.

The present patent document claims the benefit of priority to Patent Application No. 202522498845.4, filed Nov. 25, 2025, and entitled “FEMALE PLUG OUTPUT INTERFACE FOR CONTROLLER,” the entire contents of each of which are incorporated herein by reference.

### BACKGROUND

### 1. Technical Field

The present disclosure relates to the technical field of controllers, and more specifically, to a female plug output interface for a controller.

### 2. Background Information

In a traditional controller design, a female plug output interface is often externally connected as an independent component to a mainboard. This manner has many drawbacks: An output connector needs to be manually welded to the mainboard, which adds production steps, increases manufacturing costs, and reduces working efficiency. In addition, during use, contact points are prone to loosening, oxidation, and other problems. This reduces the connection stability and leads to a fault of poor contact that affects the quality of a product.

### BRIEF SUMMARY

For the shortcomings in the existing art, the present disclosure aims to provide a female plug output interface for a controller, which has high stability and high production efficiency.

To achieve the above objectives, the present disclosure provides the following technical solution: a female plug output interface for a controller includes a housing and a control mainboard arranged inside the housing. The housing is provided with an output connection assembly and an input connection assembly. The output connection assembly includes an integrally connected conductive contact sheet arranged at one end of the control mainboard and an output connector that is arranged at one end of the housing and is configured to mount the conductive contact sheet. The output connector includes a connection port for being threadedly connected to electrical equipment, two through holes symmetrically formed inside the connection port, and a connection slot that is arranged between the two through holes and is configured to insert and fix the conductive contact sheet. When an external connector is inserted into the connection port, electrodes inside the external connector are electrically connected to two sides of the conductive contact sheet and are in fastened connection with a thread on an outer wall of the connection port.

In a further setting of the present disclosure, the electrodes are arranged on the two sides of the conductive contact sheet and are configured to be electrically connected to the electrical equipment.

In a further setting of the present disclosure, a mounting slot for mounting the control mainboard is formed inside the housing; and a plurality of limiting columns for fixing the control mainboard are arranged inside the mounting slot.

In a further setting of the present disclosure, the housing is formed by connecting an upper housing with a lower housing through a detachable structure; the detachable structure includes a protrusion along a top surface portion of the lower housing and a groove that is formed in the upper housing and matches the protrusion.

In a further setting of the present disclosure, the input connection assembly includes an integrally connected connection head arranged at another end of the control mainboard; and the connection head is configured to be connected to a storage battery or is configured to be connected to a universal serial bus (USB) for power supplying.

In a further setting of the present disclosure, the lower housing is provided with a battery slot for mounting the storage battery; and a supporting column that matches the storage battery is arranged on an inner wall of the upper housing.

In a further setting of the present disclosure, the connection head includes a conductive connection portion and a threaded connection portion arranged on an outer side of the conductive connection portion; the connection head is provided with a matching external connector; the external connector includes a guide pipe and a base which match the conductive connection portion, and an outer shell that matches the threaded connection portion; and when the outer shell is connected to the threaded connection portion, the base resists against the conductive connection portion to prevent the guide pipe from falling off.

In a further setting of the present disclosure, a width of the conductive contact sheet gradually increases in an insertion direction of the connection slot, so that a reinforcement structure is formed between a tail end of the conductive contact sheet and the control mainboard.

In a further setting of the present disclosure, a sealing ring is arranged between the outer shell and the threaded connection portion to prevent inflow of rainwater.

In a further setting of the present disclosure, a control surface is further arranged on an outer wall of the upper housing to facilitate operations on the controller.

Beneficial effects of the present disclosure are as follows:

1. The proper arrangement of the output connection assembly and the input connection assembly perfects the function of the female plug output interface and clarifies the division of labor. The conductive contact sheet in the output connection assembly is integrally connected to the control mainboard. This ensures stable and efficient electricity conduction, reduces signal transmission issues caused by loose connection or poor contact, simplifies a production process, and reduces manufacturing costs. The connection port is configured to be threadedly connected with the electrical equipment, featuring high fastening performance and stability. The connection slot is arranged between the two through holes and is configured to insert and fix the conductive contact sheet. This facilitates the mounting and removal of the conductive contact sheet and can also ensure good contact between the conductive contact sheet and the electrodes inside the external connector.

2. In terms of electrical connection, the electrodes are arranged on the two sides of the conductive contact sheet, so that it greatly improves flexibility and reliability of electrical connection with the electrical equipment. The mounting slot arranged inside the housing and the plurality of limiting columns within the mounting slot provide a stable and precise mounting environment for the control mainboard, so that the control mainboard can be accurately located within the housing, and connection issues caused by positional deviation are avoided. The housing is formed by connecting the upper housing to the lower housing through the detachable structure, which provides a great convenience for production, maintenance, and upgrade of a product. The protrusion and the groove in the detachable structure are simple and practical. By the matching between the protrusion and the groove, the upper housing and the lower housing can be quickly and accurately connected, thus ensuring integrity and sealing performance of the housing.

3. In some environments without external power supplies, a stable power support can be provided for the controller by connecting the storage battery, to ensure normal operation of equipment and improve independence and portability of the equipment. Alternatively, the connection head further supports connection to the USB to supply power. In an environment without a USB interface, for example, by using a computer, a power bank, or the like, the equipment can be powered conveniently, without additionally carrying a special power adapter. This further improves flexibility and convenience of use of the equipment. The battery slot formed in the lower housing provides a dedicated mounting space for the storage battery. It can accurately position the storage battery and prevent the storage battery from shaking or shifting during use. The conductive connection portion and the threaded connection portion of the connection head, as well as the design of the matching external connector, ensure tightness and safety of connection. The conductive connection portion matches the guide pipe of the external connector. This can implement stable electrical connection and ensure smooth transmission of current and signals. The threaded connection portion is fitted to the outer shell of the external connector, so that the threaded connection portion and the outer shell are closely combined in a threaded connection manner. When the outer shell is connected to the threaded connection portion, the base resists against the conductive connection portion. This design not only improves stability of connection, prevents falling of the guide pipe, and avoids a potential safety hazard caused by loose connection.

4. The width of the conductive contact sheet gradually increases in the insertion direction of the connection slot. When the conductive contact sheet is inserted into the connection slot, the gradually widened shape ensures a better fit with the connection slot, thus improving the stability of connection. Meanwhile, a reinforced structure formed at a connection position between a tail end of the conductive contact sheet and the control mainboard, thus significantly improving firmness of connection between the conductive contact sheet and the control mainboard. The sealing ring is arranged between the outer shell and the threaded connection portion, thus forming a reliable waterproof barrier to effectively prevent rainwater, moistures, and the like from entering the interface. The control surface on the outer wall of the upper housing allows a user to perform operation and control directly through a button on the control surface, thus improving operation efficiency and lowering operation difficulty.

### BRIEF DESCRIPTION OF THE DRAWINGS

FIG. 1 is a schematic diagram of a three-dimensional structure according to the present disclosure;

FIG. 2 is an exploded view of the present disclosure;

FIG. 3 is a schematic diagram of a three-dimensional structure in another direction according to the present disclosure; and

FIG. 4 is an exploded view of Embodiment II.

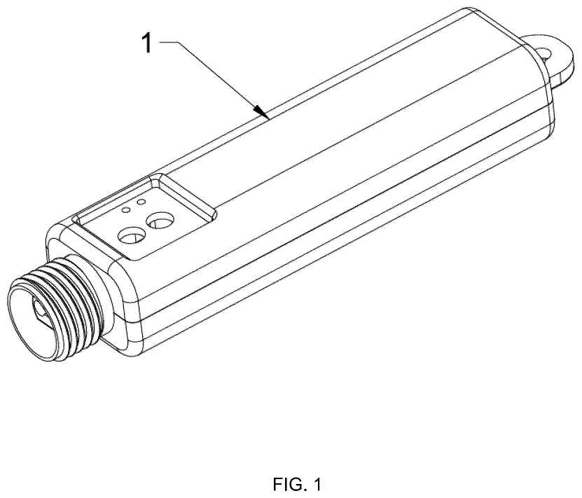

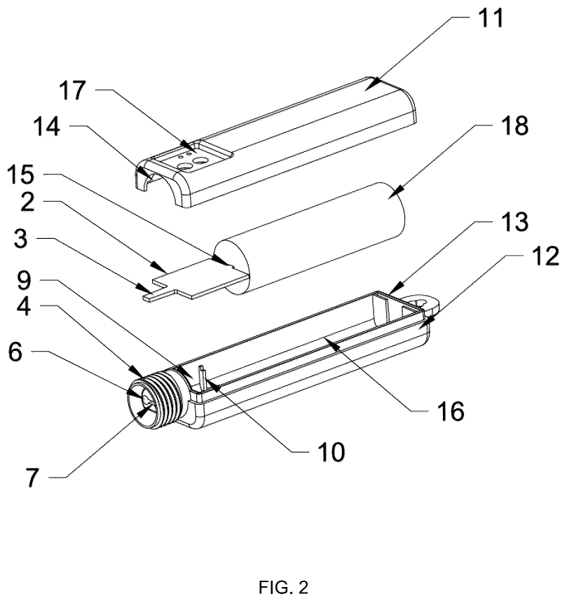

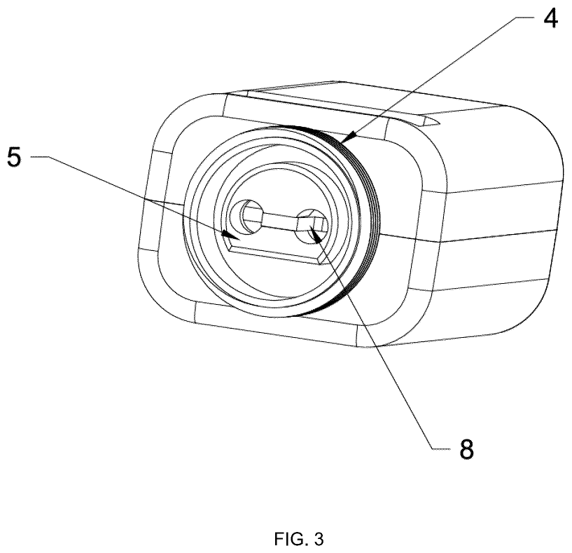

Reference numerals in FIG. 1 to FIG. 4:1: housing; 2: control mainboard; 3: conductive contact sheet; 4: output connector; 5: connection port; 6: through hole; 7: connection slot; 8: electrode; 9: mounting slot; 10: limiting column; 11: upper housing; 12: lower housing; 13: protrusion; 14: groove; 15: connection head; 16: battery slot; 17: control surface; and 18: storage battery.

### DETAILED DESCRIPTION OF THE DRAWINGS AND THE PRESENTLY PREFERRED EMBODIMENTS

Referring to FIG. 1 to FIG. 4, a further explanation will be made to the embodiments of the present disclosure.

For ease of explanation, spatial relative terms such as “up”, “down”, “left”, and “right” are used in the embodiments to illustrate a relationship between one element or feature shown in the figures and another element or feature. It should be understood that in addition to the orientations shown in the figures, the spatial terms are intended to include different orientations of a device during use or operation. For example, if the device in the figures is placed upside down, an element described as being located “below” another element or feature will be positioned as being “above” the another element or feature. Therefore, the exemplary term “down” can include both up and down orientations. The device can be positioned in other ways (rotated 90 degrees or in other orientations), and the spatial relative explanations used here can be explained correspondingly.

Moreover, relational terms such as “first” and “second” are only used to distinguish one component from another with the same name, without necessarily requiring or implying any actual relationship or order between these components.

### Embodiment I

A female plug output interface for a controller shown in FIG. 1 to FIG. 3 includes a housing 1 and a control mainboard 2 arranged inside the housing 1, so that functions of the female plug output interface are more complete and the division of labor is clarified. The housing 1 is provided with an output connection assembly and an input connection assembly. The output connection assembly includes an integrally connected conductive contact sheet 3 arranged at one end of the control mainboard 2 and an output connector 4 that is arranged at one end of the housing 1 and is configured to mount the conductive contact sheet 3. This ensures stable and efficient electricity conduction, reduces signal transmission issues caused by loose connection or poor contact, simplifies a production process, and reduces manufacturing costs. The integrated connection manner avoids additional welding or assembling procedures, improves production efficiency, improves structural reliability, and reduces a probability of failure occurrence. The output connector 4 includes a connection port 5 for being threadedly connected to electrical equipment, two through holes 6 symmetrically formed inside the connection port 5, and a connection slot 7 that is arranged between the two through holes 6 and is configured to insert and fix the conductive contact sheet 3. The connection port 5 is configured to be threadedly connected with electrical equipment. This connection manner has high fastening performance and stability. During practical use, looseness or falling of the external connector due to vibrations, pulling, or other reasons can be effectively prevented, which ensures durability and reliability of connection. The connection slot 7 is arranged between the two through holes 6 to insert and fix the conductive contact sheet 3. This facilitates mounting and removal of the conductive contact sheet 3 and can also ensure good contact between the conductive contact sheet 3 and electrodes 8 inside the external connector.

The electrodes 8 are arranged on two sides of the conductive contact sheet, so that it greatly improves flexibility and reliability of electrical connection with the electrical equipment, ensures stable transmission of signals and power, effectively reduces a fault rate caused by instable connection, and provides a solid guarantee for stable operation of an entire control system.

A mounting slot 9 for mounting the control mainboard 2 is formed inside the housing 1. A plurality of limiting columns 10 for fixing the control mainboard 2 are arranged inside the mounting slot 9. This provides a stable and precise mounting environment for the control mainboard 2. The mounting slot 9 provides a stable and precise mounting environment for the control mainboard 2, so that the control mainboard can be accurately located within the housing 1, and connection issues caused by positional deviation are avoided. The limiting columns 10 further fix the control mainboard 2 to prevent the control mainboard from shaking or shifting due to factors such as vibrations and collisions during use.

The housing 1 is formed by connecting an upper housing 11 to a lower housing 12 through a detachable structure. This brings a great convenience to the production, maintenance, and upgrade of a product. The detachable structure includes a protrusion 13 along a top surface portion of the lower housing 12 and a groove 14 that is formed in the upper housing 11 and matches the protrusion 13. Through the matching between the protrusion 13 and the groove 14, the upper housing 11 and the lower housing 12 can be quickly and accurately connected together. This ensures integrity and sealing performance of the housing 1. In a production process, this detachable structure facilitates assembling and debugging of components and improves production efficiency.

The input connection assembly includes an integrally connected connection head 15 arranged at another end of the control mainboard 2. The connection head 15 is configured to be connected to a storage battery 18 to supply a stable power support to the controller and ensure normal operation of equipment, thus improving independence and convenience of the equipment. Compared with a traditional battery connection manner, the service life of the integrally connected connection head 15 is prolonged; mounting procedures are reduced; and production efficiency is improved.

The lower housing 12 is provided with a battery slot 16 for mounting the storage battery 18. A plurality of battery slots 16 can be designed as needed to accurately position the storage battery 18 and prevent the storage battery 18 from shaking or shifting during use. Meanwhile, a supporting column that matches the storage battery 18 is arranged on an inner wall of the upper housing 11 to further improve stability of mounting of the storage battery 18.

The connection head 15 includes a conductive connection portion and a threaded connection portion arranged on an outer side of the conductive connection portion. This ensures tightness and safety of connection. The connection head 15 is provided with a matching external connector. The external connector includes a guide pipe and a base which match the conductive connection portion, and an outer shell that matches the threaded connection portion. This ensures smooth transmission of current and signals. When the outer shell is connected to the threaded connection portion, the guide pipe and the base do not rotate together with the outer shell, and finally, the base resists against the conductive connection portion to prevent the guide pipe from falling off.

A width of the conductive contact sheet 3 gradually increases in an insertion direction of the connection slot 7. When the conductive contact sheet 3 is inserted into the connection slot 7, the gradually widened shape ensures a better fit with the connection slot 7, thus improving the stability of connection. Meanwhile, a reinforced structure formed at a connection position between a tail end of the conductive contact sheet 3 and the control mainboard 2, thus significantly improving firmness of connection between the conductive contact sheet and the control mainboard.

A sealing ring is arranged between the outer shell and the threaded connection portion to provide excellent waterproof protection for the interface. In various complicated outdoor or wet environments, the sealing ring can be in close fit with the outer shell and the threaded connection portion, thus forming a reliable waterproof barrier. This effectively prevents rainwater, moistures, and the like from flowing into the interface.

A control surface 17 is further arranged on an outer wall of the upper housing 11 allows a user to perform operation and control directly through a button on the control surface, thus improving operation efficiency and lowering operation difficulty.

### Embodiment II

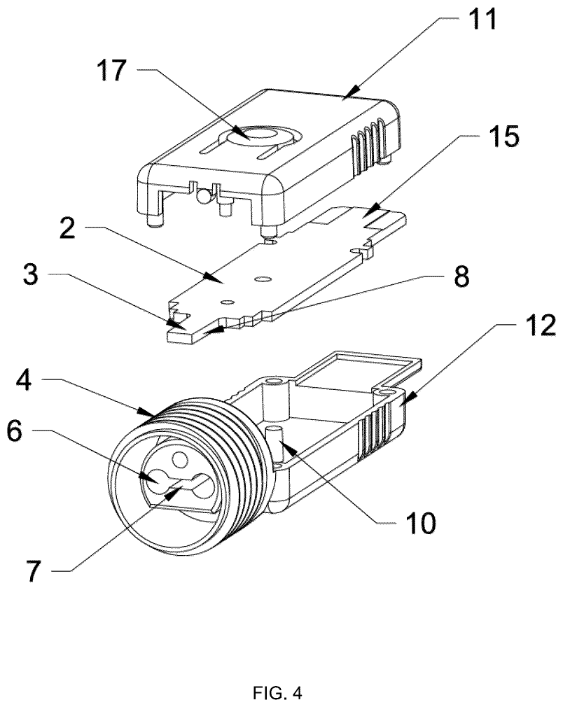

As shown in FIG. 4, it is basically the same as Embodiment I, with an only difference being that the connection head 15 is connected to a USB connector through a computer or a power bank, which can conveniently supply power to the equipment without additionally carrying a special power adapter. This further improves flexibility and convenience of use of equipment, and meets usage needs of different users in different scenarios. The connection head 15 at another end of the control mainboard 2 is fixed in a fixing slot of the lower housing 12 that is configured to fix the connection head 15, thus playing a positioning and fixing role and ensuring that the connection head 15 is more stable when connected to external USB equipment.

The above-mentioned embodiments are only preferred embodiments of the present disclosure and are not intended to limit the present disclosure, and the usual changes and substitutions made by those skilled in the art within the scopes of the technical solutions of the present disclosure shall fall within the protection scope of the present disclosure.

1. A female plug output interface for a controller, comprising a housing (1) and a control mainboard (2) arranged inside the housing (1), wherein the housing (1) is provided with an output connection assembly and an input connection assembly;
the output connection assembly comprises an integrally connected conductive contact sheet (3) arranged at one end of the control mainboard (2) and an output connector (4) that is arranged at one end of the housing (1) and is configured to mount the conductive contact sheet (3); the output connector (4) comprises a connection port (5) for being threadedly connected to electrical equipment, two through holes (6) symmetrically formed inside the connection port (5), and a connection slot (7) that is arranged between the two through holes (6) and is configured to insert and fix the conductive contact sheet (3); and when an external connector is inserted into the connection port (5), electrodes (8) inside the external connector are electrically connected to two sides of the conductive contact sheet (3) and are in fastened connection with a thread on an outer wall of the connection port (5)

2. The female plug output interface for the controller according to claim 1, wherein the electrodes (8) are arranged on the two sides of the conductive contact sheet and are configured to be electrically connected to the electrical equipment.

3. The female plug output interface for the controller according to claim 1, wherein a mounting slot (9) for mounting the control mainboard (2) is formed inside the housing (1); and a plurality of limiting columns (10) for fixing the control mainboard (2) are arranged inside the mounting slot (9).

4. The female plug output interface for the controller according to claim 1, wherein the housing (1) is formed by connecting an upper housing (11) with a lower housing (12) through a detachable structure; the detachable structure comprises a protrusion (13) along a top surface portion of the lower housing (12) and a groove (14) that is formed in the upper housing (11) and matches the protrusion (13).

5. The female plug output interface for the controller according to claim 4, wherein the input connection assembly comprises an integrally connected connection head (15) arranged at another end of the control mainboard (2); and the connection head (15) is configured to be connected to a storage battery (18) or is configured to be connected to a universal serial bus (USB) for power supplying.

6. The female plug output interface for the controller according to claim 5, wherein the lower housing (12) is provided with a battery slot (16) for mounting the storage battery (18); and a supporting column that matches the storage battery (18) is arranged on an inner wall of the upper housing (11).

7. The female plug output interface for the controller according to claim 1, wherein the connection head (15) comprises a conductive connection portion and a threaded connection portion arranged on an outer side of the conductive connection portion; the connection head (15) is provided with a matching external connector; the external connector comprises a guide pipe and a base which match the conductive connection portion, and an outer shell that matches the threaded connection portion; and when the outer shell is connected to the threaded connection portion, the base resists against the conductive connection portion to prevent the guide pipe from falling off.

8. The female plug output interface for the controller according to claim 1, wherein a width of the conductive contact sheet (3) gradually increases in an insertion direction of the connection slot (7), so that a reinforcement structure is formed between a tail end of the conductive contact sheet (3) and the control mainboard (2).

9. The female plug output interface for the controller according to claim 7, wherein a sealing ring is arranged between the outer shell and the threaded connection portion to prevent inflow of rainwater.

10. The female plug output interface for the controller according to claim 1, wherein a control surface (17) is further arranged on an outer wall of the upper housing (11) to facilitate operations on the controller.
